(19) United States
(12) Patent Application Publication
(10) Pub. No.: US 2025/0186895 A1
(43) Pub. Date: Jun. 12, 2025

(54) PROGRAM, INFORMATION PROCESSING APPARATUS, METHOD, AND SYSTEM

(71) Applicant: CYGAMES, INC., Tokyo (JP)

(72) Inventors: Takefumi Tokoeda, Tokyo (JP); Shintaro Matsumura, Tokyo (JP); Yasunori Horino, Tokyo (JP)

(73) Assignee: CYGAMES, INC., Tokyo (JP)

(21) Appl. No.: 19/062,676

(22) Filed: Feb. 25, 2025

Related U.S. Application Data
(63) Continuation of application No. PCT/JP2023/033861, filed on Sep. 19, 2023.

(30) Foreign Application Priority Data
Sep. 28, 2022 (JP) 2022-155456

(51) Int. Cl. A63F 13/792; A63F 13/537

(52) U.S. Cl. CPC A63F 13/792; A63F 13/537

(57) ABSTRACT

An information processing apparatus including a first game execution unit configured to execute a first game in exchange for a first item or predetermined currency based on an operation on a first input reception portion configured to allow execution of the first game, a purchase execution unit configured to associate a player who purchases a game purchase content including at least the first item with the game purchase content in exchange for the predetermined currency, a determination unit configured to determine, based on purchasability/unpurchasability information associated with the player of the game purchase content, whether the game purchase content is purchasable by the player, and a display control unit configured to present, when it is determined that the game purchase content is purchasable, a purchasability display in a game screen including the first input reception portion, the purchasability display indicating that the game purchase content is purchasable.

### TECHNICAL FIELD

The present invention relates to a program and the like, and particularly to a program of a game and the like for executing a first game included in the game in exchange for a first item or predetermined currency.

### BACKGROUND ART

Games in the related art may include a first game executable in exchange for a first item or predetermined currency. In other words, a player can execute the first game using either the first item or the predetermined currency.

### CITATION LIST

### Patent Literature

Patent Document 1: JP 6676207 B

### SUMMARY OF INVENTION

### Technical Problem

In such a game, a measure for selling a game purchase content including at least the first item is widely taken. Although information on the measure is notified in the game or distributed through a social network service (SNS) and the like, the information may not be recognized by the player. Therefore, the player may not notice that there is a game purchase content that has not been purchased, making it difficult to improve the player's game experience.

The present invention has been made to solve such a problem, and an object thereof is to provide a program, an information processing apparatus, a method, and a system capable of improving a player's game experience.

### Solution to Problem

A program according to an aspect of the present invention is a program for a game, the program causing a computer to function as
a first game executor configured to execute a first game included in the game in exchange for a first item or predetermined currency based on an operation on a first input reception portion configured to allow execution of the first game,
a purchase executor configured to associate a player who purchases a game purchase content including at least the first item with the game purchase content in exchange for the predetermined currency,
a determiner configured to determine, based on purchasability/unpurchasability information associated with the player of the game purchase content, whether the game purchase content is purchasable by the player, and
a display controller configured to present, when it is determined that the game purchase content is purchasable, a purchasability display in a game screen including the first input reception portion, the purchasability display indicating that the game purchase content is purchasable.

The program according to an aspect of the present invention may include at least one or more of the following configurations [2] to [8]:
[2] the game purchase content includes the first item and another game content that is different from the first item and that is usable in the game;
[3] the display controller directly transitions, based on a predetermined operation by the player, the game screen to a purchase screen configured to allow purchase of the game purchase content;
[4] the display controller displays, based on a predetermined operation by the player, a selection screen including a second input reception portion and a third input reception portion, the second input reception portion being configured to allow execution of the first game in exchange for the first item, the third input reception portion being configured to allow execution of the first game in exchange for the predetermined currency, and
the first game executor executes the first game based on selection of the second input reception portion or the third input reception portion by the player;
[5] in the configuration [4], the selection screen further includes a fourth input reception portion configured to allow purchase of the game purchase content;
[6] the first input reception portion includes a second input reception portion and a third input reception portion, the second input reception portion being configured to allow execution of the first game in exchange for the first item, the third input reception portion being configured to allow execution of the first game in exchange for the predetermined currency,
the display controller displays the second input reception portion and the third input reception portion such that the second input reception portion and the third input reception portion are included in the game screen, and
the first game executor executes the first game based on selection of the second input reception portion or the third input reception portion by the player;
[7] the first game executor determines whether the player possesses the first item based on an operation by the player on the first input reception portion, executes the first game in exchange for the first item when the player possesses the first item, and executes the first game in exchange for the predetermined currency when the player does not possess the first item; and
[8] when the player possesses the first item, the display controller presents, in the game screen, a possession display indicating that the player possesses the first item.

An information processing apparatus according to an aspect of the present invention is an information processing apparatus for executing a game, the information processing apparatus including
a first game executor configured to execute a first game included in the game in exchange for a first item or predetermined currency based on an operation on a first input reception portion configured to allow execution of the first game,
a purchase executor configured to associate a player who purchases a game purchase content including at least the first item with the game purchase content in exchange for the predetermined currency,
a determiner configured to determine, based on purchasability/unpurchasability information associated with the player of the game purchase content, whether the game purchase content is purchasable by the player, and
a display controller configured to present, when it is determined that the game purchase content is purchasable, a purchasability display in a game screen including the first input reception portion, the purchasability display indicating that the game purchase content is purchasable.

A method according to an aspect of the present invention is a method for a game, the method including
a first game execution step of executing a first game included in the game in exchange for a first item or predetermined currency based on an operation on a first input reception portion configured to allow execution of the first game,
a purchase execution step of associating a player who purchases a game purchase content including at least the first item with the game purchase content in exchange for the predetermined currency,
a determination step of determining, based on purchasability/unpurchasability information associated with the player of the game purchase content, whether the game purchase content is purchasable by the player, and
a display control step of presenting, when it is determined that the game purchase content is purchasable, a purchasability display in a game screen including the first input reception portion, the purchasability display indicating that the game purchase content is purchasable.

A system according to an aspect of the present invention is a system for executing a game, the system including
a plurality of information processing apparatuses, wherein
at least any of the plurality of information processing apparatuses functions as a first game executor configured to execute a first game included in the game in exchange for a first item or predetermined currency based on an operation on a first input reception portion configured to allow execution of the first game,
at least any of the plurality of information processing apparatuses functions as a purchase executor configured to associate a player who purchases a game purchase content including at least the first item with the game purchase content in exchange for the predetermined currency,
at least any of the plurality of information processing apparatuses functions as a determiner configured to determine, based on purchasability/unpurchasability information associated with the player of the game purchase content, whether the game purchase content is purchasable by the player, and
at least any of the plurality of information processing apparatuses functions as a display controller configured to present, when it is determined that the game purchase content is purchasable, a purchasability display in a game screen including the first input reception portion, the purchasability display indicating that the game purchase content is purchasable.

### Advantageous Effects of Invention

According to the present invention, it is possible to improve a player's game experience.

### BRIEF DESCRIPTION OF DRAWINGS

FIG. 1 is a block diagram illustrating a hardware configuration of an information processing apparatus according to an embodiment of the present invention.

FIG. 2 is an example of a functional block diagram of the information processing apparatus according to the embodiment of the present invention.

FIG. 3 is an example of a functional block diagram of a game control unit according to the embodiment of the present invention.

FIG. 4 illustrates an example of a first game screen according to the embodiment of the present invention.

FIG. 5 illustrates an example of a selection screen according to the embodiment of the present invention.

FIG. 6 illustrates an example of a first item selection screen according to the embodiment of the present invention.

FIG. 7 illustrates an example of a purchase screen according to the embodiment of the present invention when a first switching portion is selected.

FIG. 8 illustrates an example of a purchase confirmation screen according to the embodiment of the present invention.

FIG. 9 illustrates an example of a purchase result screen according to the embodiment of the present invention.

FIG. 10 illustrates an example of the purchase screen according to the embodiment of the present invention when a second switching portion is selected.

FIG. 11 illustrates another example of the purchase confirmation screen according to the embodiment of the present invention.

FIG. 12 illustrates another example of the purchase result screen according to the embodiment of the present invention.

FIG. 13 illustrates an example of the purchase screen according to the embodiment of the present invention when a third switching portion is selected.

FIG. 14 illustrates another example of the purchase confirmation screen according to the embodiment of the present invention.

FIG. 15 illustrates another example of the purchase result screen according to the embodiment of the present invention.

FIG. 16 illustrates an example of the purchase screen according to the embodiment of the present invention when the fourth switching portion is selected.

FIG. 17 illustrates another example of the purchase confirmation screen according to the embodiment of the present invention.

FIG. 18 illustrates another example of the purchase result screen according to the embodiment of the present invention.

FIG. 19 illustrates another example of the first game screen according to the embodiment of the present invention.

FIG. 20 is an example of an operation flowchart of the information processing apparatus according to the embodiment of the present invention.

FIG. 21 illustrates an example of a selection screen according to a modified example of the embodiment of the present invention.

FIG. 22 illustrates an example of a first game screen according to the modified example of the embodiment of the present invention.

FIG. 23 illustrates another example of the first game screen according to the modified example of the embodiment of the present invention.

FIG. 24 illustrates an example of an overall configuration of a system according to the embodiment of the present invention.

### DESCRIPTION OF EMBODIMENTS

A game system according to an embodiment of the present invention will be described with reference to the drawings. In the present specification, for convenience of description, a detailed description more than necessary may be omitted. For example, a detailed description of an already well-known matter and a redundant description of substantially the same configuration may be omitted.

This game system can be achieved by a system in which a plurality of information processing apparatuses are connected via a network, but can also be achieved by a single information processing apparatus. First, an embodiment achieved by one information processing apparatus will be described, and then a system connected to a network will be described.

### Embodiment Achieved by Information Processing Apparatus

### Configuration

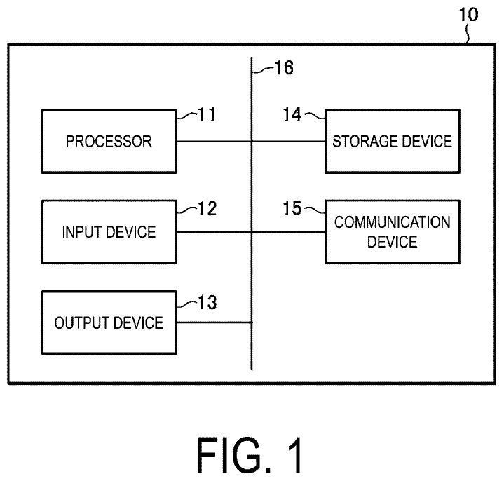

FIG. 1 is a block diagram illustrating a hardware configuration of an information processing apparatus 10 according to an embodiment of the present invention. The information processing apparatus 10 includes a processor 11, an input device 12, an output device 13, a storage device 14, and a communication device 15. Each of the components 11 to 15 is connected via a bus 16. Note that an interface may be interposed between the bus 16 and each of the components 11 to 15 as necessary. In the present embodiment, the information processing apparatus 10 is a smartphone. However, the information processing apparatus 10 can be a terminal such as a tablet computer or a computer including a contact-type input device such as a touch pad as long as the information processing apparatus 10 has the above-described configuration.

The processor 11 controls the overall operation of the information processing apparatus 10 and is an electronic circuit such as a CPU or an MPU. The processor 11 executes various types of processing by reading and executing programs and data stored in the storage device 14. In one example, the processor 11 includes a plurality of processors.

The input device 12 is a user interface that receives an input from a user to the information processing apparatus 10, and is, for example, a touch panel, a touch pad, a keyboard, or a mouse. Since the information processing apparatus 10 of the present embodiment is a smartphone, the information processing apparatus 10 includes a touch panel. This touch panel functions as both the input device 12 and the output device 13. The input device 12 and the output device 13 may be in separate forms disposed at different positions.

The output device 13 displays an application screen or the like for the user of the information processing apparatus 10, that is, a player, under control of the processor 11. As the output device 13, a liquid crystal display, an organic EL display, a plasma display, a speaker that emits sound, a printer, or the like can be used.

The storage device 14 includes a main memory, a buffer memory, and a storage, and is a storage device included in a typical smartphone or computer, such as a storage device using a RAM, which is a volatile memory, and a flash memory such as an eMMC, a UFS, or an SSD, which is a non-volatile memory, and a magnetic storage device. The storage device 14 can include an external memory. The storage device 14 stores, for example, a game application. The game application includes a game program for executing a game, and various types of data and various tables referred to when the game program is executed. The game program is started in response to an operation by the user on the information processing apparatus 10, and executed on an operating system (OS) installed in advance in the information processing apparatus 10.

In one example, the storage device 14 includes a main storage device and an auxiliary storage device. The main storage device is a volatile storage medium capable of high-speed reading and writing of information, and is used as a storage area and a work area when the processor 11 processes information. The auxiliary storage device stores various programs and data used by the programs when the programs are executed. The auxiliary storage device is, for example, an SSD or a hard disk device, but may be any non-volatile storage or non-volatile memory as long as information can be stored therein, and may be a detachable device. The auxiliary storage device stores, for example, an operating system (OS), middleware, an application program, and various types of data that can be referred to along with execution of these programs.

The communication device 15 transmits and receives data to and from another computer such as a server via a network. For example, the communication device 15 performs wireless communication such as mobile communication or wireless LAN and is connected to the network. In one example, in the information processing apparatus 10, a program is downloaded by the communication device 15 from the server and stored in the storage device 14. However, the communication device 15 may perform wired communication using an Ethernet (trade name) cable or the like. When data is not transmitted to or received from another computer, the information processing apparatus 10 does not need to include the communication device 15.

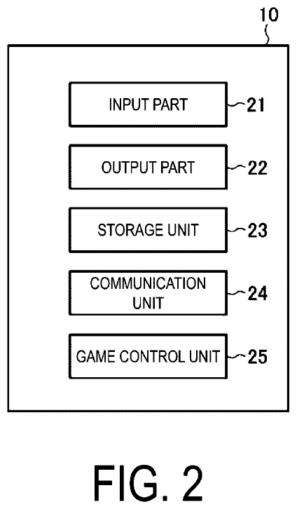

FIG. 2 is an example of a functional block diagram of the information processing apparatus 10 according to the embodiment of the present invention. The information processing apparatus 10 includes an input part 21, an output part 22, a storage unit 23, a communication unit 24, and a game control unit 25. In the present embodiment, these functions are implemented by the processor 11 executing a program. For example, the executed program is a game program stored in the storage device 14 or received via the communication device 15. In this way, since various functions are implemented by reading the program, one part (function) may be partially or wholly included in another part. The various functions are implemented as respective units by executing the program. By configuring an electronic circuit or the like for partially or wholly implementing each function, these functions may be implemented by hardware.

The input part 21 is configured using the input device 12 and receives an input from the user to the information processing apparatus 10. The output part 22 is configured using the output device 13, and presents information related to a game to the information processing apparatus 10 in order to present the information to the user. The storage unit 23 is configured using the storage device 14, and stores information and programs related to various games. The communication unit 24 is configured using the communication device 15, and functions as an interface that transmits and receives information to and from an external device such as another information processing apparatus 10. The communication unit 24 may transmit input information from the user received by the input part 21 to the external device such as the other information processing apparatus 10 via the network. Further, the communication unit 24 may receive information from the external device such as the other information processing apparatus 10 and transmit the information to each unit.

The game control unit 25 performs basic control when executing a game of the present embodiment. The game control unit 25 is configured to include the processor 11, executes the game, and causes the output device 13 to display a screen related to the game. The execution of the game by the game control unit 25 can include acquiring information necessary for the execution from the storage device 14, acquiring operation information on the player via the input device 12, the communication device 15, and/or the network, performing information processing of the game based on the necessary information, and generating and/or acquiring, based on the information processing, information necessary for displaying a screen to be displayed on the output device 13.

Next, the game and the game control unit 25 of the present embodiment will be described in detail. The game of the present embodiment includes a plurality of games.

First, the game of the present embodiment includes a game played using a game content selected by the player, and can be executed by the game control unit 25. The game is a series of games from the start to the end in which predetermined parameters such as a physical strength, a hit point, and a life can be consumed during the play. The present embodiment can be applied to various games such as a rhythm game (also referred to as a music game), a life simulation game, a role-playing game (RPG), a match game, and an action game as long as the games are played using a game content selected by the player. The game of the present embodiment is a rhythm game unless otherwise specified. In the rhythm game, the player selects a song to be played from among a plurality of songs, and selects a game content to be used for the song from among a plurality of game contents. While the sound of the selected song is output from the output device 13 (for example, a speaker), a rhythm icon called notes, which moves on a game screen displayed on the output device 13 (display device), moves toward an icon of the selected game content on the game screen, and the player performs an operation such as tapping or flicking the icon of the game content at a timing such as a moment when the rhythm icon overlaps the icon of the game content, and acquires a score. More specifically, the rhythm game is a rhythm game of a live show type in which the selected song is sung and/or played by a group including a plurality of game contents (for example, pop stars). The sound of the selected song is output from the speaker, a situation in which the selected game content (pop star) plays a live show, the rhythm icon, and the icon of the game content are displayed on the game screen, and the player performs an operation at an appropriate timing, so that parameters such as a score and an ability of the game content are changed.

Next, the game of the present embodiment includes a first game. The first game is a game executable in exchange for a first item or predetermined currency. The first game can be any game such as a lottery game or a quest. The first game can be a game in which a player ID is associated with a game content, a parameter, and a reward such as a change in the parameter. The first game of the present embodiment is a lottery game. The lottery game is a game in which a game content usable in the game is given to the player by lottery. The game content is electronic data used in the game, such as a character, a weapon, an item, and an equipment item such as a card. For example, a rank, a degree of rarity, or the like is associated with each game content, and a probability of giving the game content can be set according to the rank or the degree of rarity.

The first item and the predetermined currency are game contents associated with the player. For example, the first item and the predetermined currency are associated with the player ID for uniquely identifying the player. The first item is a game content exchangeable for execution of the first game. The first item can be a ticket for executing the first game. The first item can be a ticket that allows execution of the first game once or a ticket that allows execution of the first game a plurality of times (for example, ten times). The predetermined currency is in-game currency usable in the game, and is a game content exchangeable not only for execution of the first game but also for any game content as long as the game content is usable in the game. The predetermined currency may be predetermined currency (hereinafter also referred to as “paid predetermined currency”) that can be acquired only by cash purchase or the like, or may be predetermined currency (hereinafter also referred to as “free predetermined currency”) that can be acquired by other than cash purchase or the like, such as mission clear. The predetermined currency of the present embodiment is paid predetermined currency. The predetermined currency may be currency usable inside and outside the game. That is, the predetermined currency may be currency other than in-game currency. The currency other than in-game currency is, for example, cash, electronic money, or other currency usable outside the game.

### Game Control Unit

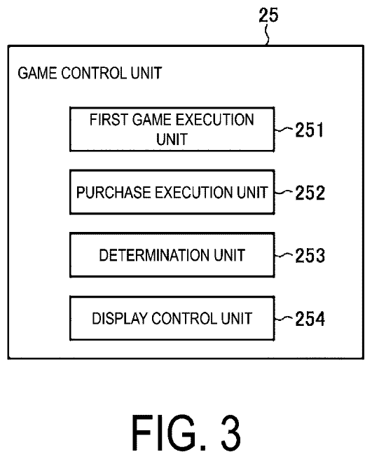

FIG. 3 is an example of a functional block diagram of the game control unit. As illustrated in FIG. 3, the game control unit 25 includes a first game execution unit 251, a purchase execution unit 252, a determination unit 253, and a display control unit 254.

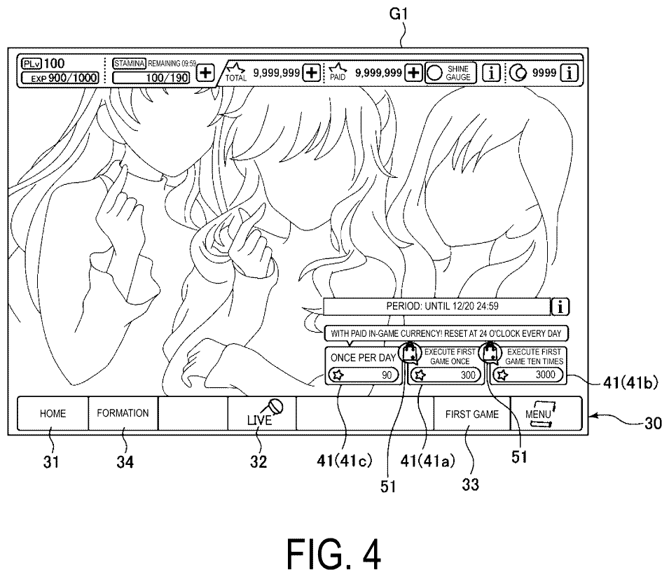

The first game execution unit 251 is configured to include the processor 11, and executes the first game in exchange for a first item or predetermined currency based on an operation on a below-described first input reception portion 41 (see FIG. 4) for executing the first game. For example, when the first item is a ticket that allows execution of the first game a predetermined number of times (for example, once or ten times), the first game execution unit 251 executes the first game the predetermined number of times (for example, once or ten times). The first game execution unit 251 executes the first game a predetermined number of times (for example, once or ten times) in exchange for predetermined currency for executing the first game the predetermined number of times (for example, once or ten times).

The first game execution unit 251 can change the quantity of first items or predetermined currency associated with the player along with execution of the first game. Specifically, the first game execution unit 251 can subtract the quantity of exchanged first items from the quantity of first items associated with the player, and store the quantity after the subtraction in the storage device 14 in association with the player. In addition, the first game execution unit 251 can subtract the quantity of exchanged predetermined currency from the quantity of predetermined currency associated with the player, and store the quantity after the subtraction in the storage device 14 in association with the player.

Along with execution of the first game (lottery game), the first game execution unit 251 can store a game content determined by the lottery in the storage device 14 in association with the player. Accordingly, the player can use the game content acquired by the lottery in the game.

The purchase execution unit 252 is configured to include the processor 11, and associates the player who purchases a game purchase content with the game purchase content in exchange for predetermined currency. In one example, the purchase execution unit 252 associates a game purchase content designated by the player with the player ID in exchange for the quantity of predetermined currency equivalent to the game purchase content. Thus, the player can acquire the game purchase content.

The game purchase content includes at least a first item. The game purchase content may be only the first item, but the game purchase content of the present embodiment includes the first item and another game content that is different from the first item and that is usable in the game. Examples of the other game content include various tickets, a voting ticket, clothes of a game content (for example, a character) used in the rhythm game, an item, and other game contents. The various tickets can include a special ticket exchangeable for any game content (for example, a character) desired by the player or a predetermined game content (for example, a character or an item). The voting ticket is a ticket that allows, in a general election of a character (for example, a pop star character) used in the rhythm game, the player to vote for the character. The general election is appropriately performed in the game, for example, once a year. The clothes are objects displayed in the rhythm game, and can include ordinary clothes that a game content (for example, a character) can wear and a dress or stage clothes that a game content (for example, a character) used in the rhythm game can wear at a stage. In this way, the game purchase content of the present embodiment is sold as a set of the first item and the other game content.

The quantity of predetermined currency for the game purchase content can be equal to or less than the quantity of predetermined currency for executing the first game. In one example, when the quantity of predetermined currency for executing the first game once is 300, the quantity of predetermined currency for a game purchase content that is a set of a first item for executing the first game once and another game content is equal to or less than 300. In another example, when the quantity of predetermined currency for executing the first game ten times is 3000, the quantity of predetermined currency for a game purchase content that is a set of a first item for executing the first game ten times and another game content is equal to or less than 3000. The quantity of predetermined currency for a game purchase content means the quantity of predetermined currency necessary for purchasing the game purchase content.

The purchase execution unit 252 can subtract the quantity of exchanged predetermined currency from the quantity of predetermined currency associated with the player, and store the quantity after the subtraction in the storage device 14 in association with the player.

The determination unit 253 is configured to include the processor 11, and determines whether the player can purchase a game purchase content based on purchasability/unpurchasability information of the game purchase content. The purchasability/unpurchasability information is associated with each player for each game purchase content. For example, the purchasability/unpurchasability information is data of 0 or 1, and can be set to 0 when a certain game purchase content can be purchased by a certain player, and can be set to 1 when the certain game purchase content cannot be purchased by the certain player. The purchasability/unpurchasability information of a game purchase content that the player has already purchased once can be data indicating that purchase is impossible (for example, 1). The purchasability/unpurchasability information of a game purchase content purchased by the purchase execution unit 252 can be updated by the purchase execution unit 252. In one example, when the number of times of purchase of a game content reaches a predetermined number of times, the purchase execution unit 252 changes the purchasability/unpurchasability information of the game content. For example, the purchase execution unit 252 changes the purchasability/unpurchasability information of a game purchase content that has been purchased once from information indicating that purchase is possible (for example, data of 0) to information indicating that purchase is impossible (for example, data of 1). In another example, when a time during which a game content can be purchased changes to a time during which the game content cannot be purchased in the real time or in-game time (for example, a case where the game content can be purchased only in one week after game start), the purchase execution unit 252 changes the purchasability/unpurchasability information of the game content from information indicating that purchase is possible (for example, data of 0) to information indicating that purchase is impossible (for example, data of 1). In addition, when a time during which a game content cannot be purchased changes to a time during which the game content can be purchased in the real time or in-game time, the purchase execution unit 252 changes the purchasability/unpurchasability information of the game content from information indicating that purchase is impossible (for example, data of 1) to information indicating that purchase is possible (for example, data of 0). In another example, the purchase execution unit 252 can change the purchasability/unpurchasability information of a game content that cannot be purchased to information indicating that purchase is possible after elapse of a predetermined period of time or at a predetermined time. For example, before a campaign period starts, the purchase execution unit 252 resets the purchasability/unpurchasability information of a game content that cannot be purchased, and changes the purchasability/unpurchasability information to information indicating that purchase is possible.

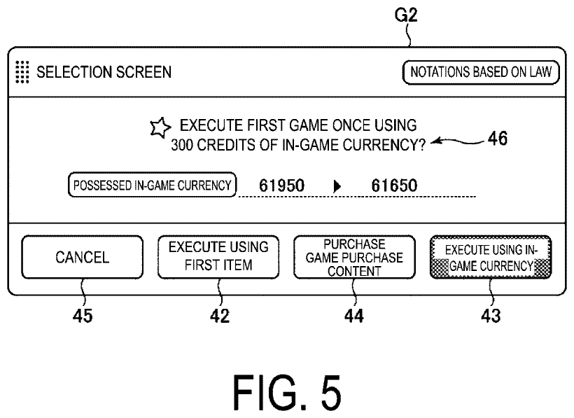

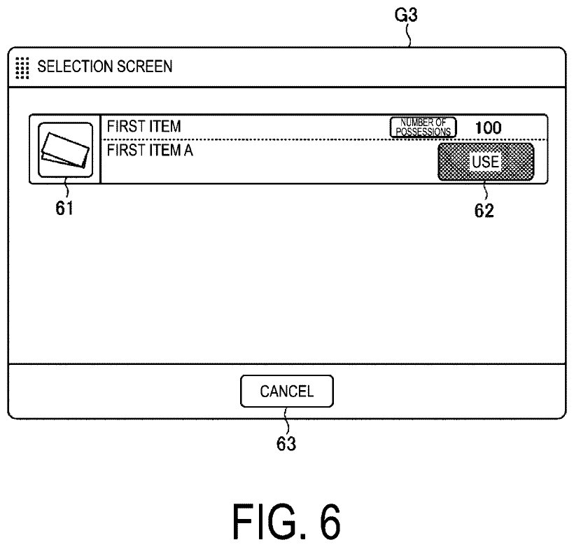

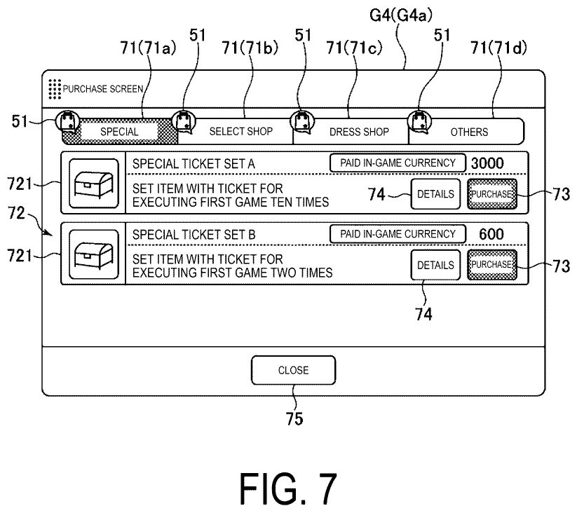

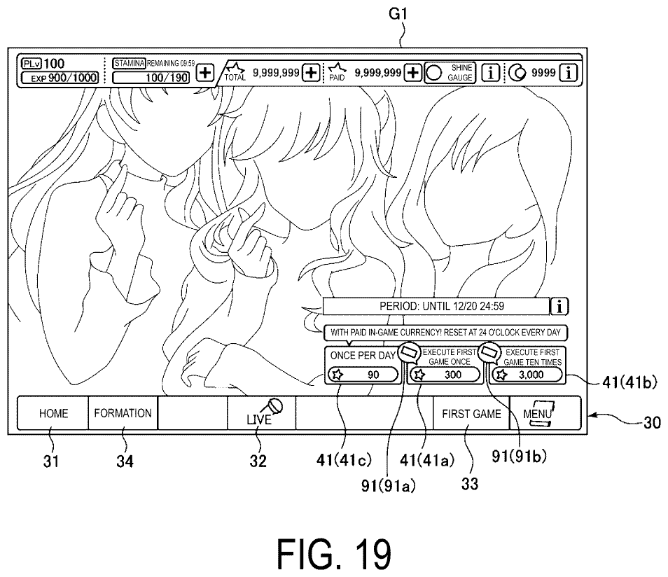

The display control unit 254 is configured to include the processor 11, and controls the output device 13 (hereinafter, an output device that performs output in the form of display will be referred to as a display device 13 below). The display control unit 254 causes the display device 13 to display a predetermined screen based on a predetermined operation by the player. Examples of the predetermined operation by the player can include an input operation by the player on a first game button 33 (see FIG. 4), the first input reception portion 41 (see FIG. 4), a second input reception portion 42 (see FIG. 5), a third input reception portion 43 (see FIG. 5), or a fourth input reception portion 44 (see FIG. 5). Examples of the predetermined screen can include a first game screen G1 (see FIGS. 4 and 19), a selection screen G2 (see FIG. 5), a first item selection screen G3 (see FIG. 6), and a purchase screen G4 (see FIGS. 7, 10, 13, and 16).

When it is determined that a game purchase content can be purchased, the display control unit 254 presents a purchasability display (for example, see the reference numeral 51 in FIG. 4) indicating that the game purchase content can be purchased in a game screen (for example, the first game screen G1 in FIG. 4) including the first input reception portion 41. In addition, the display control unit 254 can present at least a part of the purchasability display such that it is superimposed on the first input reception portion 41 in the game screen (for example, the first game screen G1 in FIG. 4) including the first input reception portion 41 (for example, see FIG. 4). Superimposing at least a part of the purchasability display on the first input reception portion 41 can include providing the purchasability display at a position corresponding to the first input reception portion 41, or in the vicinity of, around, or in the periphery of the first input reception portion 41. The purchasability display (for example, see the reference numeral 51 in FIG. 4) is a display such as a mark or an icon indicating that a game purchase content can be purchased. The purchasability display is not limited to a mark or an icon, and can include a change in a display mode of a display color or size of a character, a figure, a symbol, or the like related to any of the input reception portions 41 to 44, and an additional display of a mark, an icon, or the like for any of the input reception portions 41 to 44.

The display control unit 254 can directly transition, based on a predetermined operation by the player, the game screen (first game screen G1) including the first input reception portion 41 to a purchase screen (for example, the purchase screen G4 in FIG. 6) for purchasing a game purchase content. Note that the expression “directly transition” can include completely switching the screen from the first game screen G1 to the purchase screen G4 and, as described below, a pop-up display in which the purchase screen G4 is displayed in a superimposed manner on the first game screen G1 in a state in which the first game screen G1 is displayed on the display device 13. The predetermined operation by the player is, for example, an input operation by the player on the first input reception portion 41.

The screens G1 to G4 will be described in detail.

FIG. 4 is an example of the first game screen G1. The first game screen G1 is a screen that the display control unit 254 causes the display device 13 to display based on an input operation by the player on the first game button 33 described below.

As illustrated in FIG. 4, the first game screen G1 includes a mode switching portion 30 and one or more first input reception portions 41. The mode switching portion 30 switches a game mode based on an input operation by the player. That is, the game of the present embodiment includes a plurality of games and thus includes a plurality of game modes. The mode switching portion 30 can be displayed on the screen of each game mode, and can receive an operation of switching the game mode. In the example illustrated in FIG. 4, the mode switching portion 30 is displayed at a lower portion of the first game screen G1.

The mode switching portion 30 includes a home button 31, a rhythm game button 32, the first game button 33, and a formation button 34. The home button 31 is a button for transitioning the displayed screen (the first game screen G1 in FIG. 4) to a home screen (not illustrated). The rhythm game button 32 is a button for switching the mode to a rhythm game mode and executing the rhythm game. The player performs an input operation on the rhythm game button 32, and thus the player can select a game content (for example, a character), a formation, and a song to be used in the rhythm game to execute the rhythm game. The first game button 33 is a button for switching the mode to a mode for executing the first game. The first game screen G1 is a screen displayed by the display control unit 254 when the player performs an input operation on the first game button 33 on the home screen. The formation button 34 is a button for displaying a formation screen (not illustrated). The formation screen is a screen for forming a character group (for example, a pop star group) to be used in the rhythm game. The character group is composed of a plurality of characters. The formed character group can be registered by, for example, being stored in the storage device 14 by the game control unit 25.

The first input reception portion 41 is a portion for executing the first game, and is an input reception portion (for example, a button) that receives an input operation by the player. The first input reception portion 41 of the present embodiment includes a plurality of first input reception portions 41a to 41c. The first input reception portion 41a is an input reception portion for executing the first game once in exchange for a first item or predetermined currency. The first input reception portion 41b is an input reception portion for executing the first game a plurality of times (here, ten times) in exchange for a first item or predetermined currency. The first input reception portion 41c is an input reception portion for executing the first game a predetermined number of times within a first predetermined period in exchange for a first item or predetermined currency. In the example illustrated in FIG. 4, the first predetermined period is one day, and the predetermined number of times is one. A period during which the first game can be executed via the first input reception portion 41c can be set to a second predetermined period. The second predetermined period is a campaign period, and can be, for example, several days, several weeks, one month, or several months.

The first game screen G1 can include a purchasability display 51. The purchasability display 51 is a display such as a mark or an icon indicating that a game purchase content is purchasable. Here, the purchasability display 51 is a mark or an icon of an item such as a bag. The purchasability display 51 can be presented in the first game screen G1, and here, at least a part of the purchasability display 51 is presented in a superimposed manner on each first input reception portion 41 in the first game screen G1. Note that the purchasability display 51 is not limited to a mark or an icon, and may be a change in a display mode of a display color or size of a character, a figure, a symbol, or the like related to any of the input reception portions 41 to 44.

When the player performs an input operation on any of the first input reception portions 41a to 41c, the display control unit 254 causes the display device 13 to display the selection screen G2.

FIG. 5 is an example of the selection screen G2. The selection screen G2 is a screen displayed when each first input reception portion 41 receives an input operation by the player. Here, the selection screen G2 is a selection screen when the first input reception portion 41a is selected by the player. The selection screen G2 is a pop-up display presented in a superimposed manner on the first game screen G1. However, the selection screen G2 may be displayed after screen transition from the first game screen G1.

The selection screen G2 includes the second input reception portion 42 for executing the first game in exchange for a first item, and the third input reception portion 43 for executing the first game in exchange for predetermined currency, and can further include the fourth input reception portion 44 for purchasing a game purchase content, a cancel reception portion 45, and a confirmation display region 46.

The second input reception portion 42 can be an input reception portion (for example, a button) for executing the first game using a first item. Specifically, the player performs an input operation on the second input reception portion 42, and thus the display control unit 254 displays the first item selection screen G3 instead of the selection screen G2 or on the selection screen G2. The first item selection screen G3 is a screen that allows the player to select a first item to be exchanged for execution of the first game from among first items possessed by the player, and will be described in detail below. When the player possesses no first item, the second input reception portion 42 can be grayed out by the display control unit 254, for example. In this case, the second input reception portion 42 does not receive an input operation by the player.

The third input reception portion 43 can be an input reception portion (for example, a button) for executing the first game using predetermined currency. Specifically, the player performs an input operation on the third input reception portion 43, and thus the display control unit 254 displays a first game execution screen (not illustrated) instead of the selection screen G2 or on the selection screen G2. The first game execution screen is a screen displayed during execution of the first game, and can include a display of a lottery result and the like during the lottery. Note that the player performs an input operation on the third input reception portion 43, and thus the first game execution unit 251 executes the first game in exchange for predetermined currency. When predetermined currency possessed by the player is insufficient, the third input reception portion 43 can be grayed out by the display control unit 254, for example. In this case, the third input reception portion 43 does not receive an input operation by the player.

The fourth input reception portion 44 can be an input reception portion (for example, a button) for purchasing a game purchase content. Specifically, the player performs an input operation on the fourth input reception portion 44, and thus the display control unit 254 displays the purchase screen G4 instead of the selection screen G2 or on the selection screen G2. The purchase screen G4 is a screen that allows purchase of a game purchase content, and will be described in detail below. When there is no game purchase content that has not been purchased, the fourth input reception portion 44 can be grayed out by the display control unit 254, for example. In this case, the fourth input reception portion 44 does not receive an input operation by the player.

The cancel reception portion 45 can be a button for returning the screen to the first game screen G1. That is, the display control unit 254 displays the first game screen G1 instead of the selection screen G2 based on an input operation by the player on the cancel reception portion 45.

The confirmation display region 46 is a region for displaying the quantity of predetermined currency to be exchanged for execution of the first game, the quantity of predetermined currency currently possessed by the player, and the remaining quantity of predetermined currency of the player after execution of the first game. Due to the selection screen G2, the player can confirm the quantity of predetermined currency to be exchanged for execution of the first game, and can select whether to exchange a first item or predetermined currency to execute the first game.

FIG. 6 illustrates an example of the first item selection screen G3. The first item selection screen G3 is a screen displayed on the display device 13 when the second input reception portion 42 receives an input operation by the player. Here, the first item selection screen G3 is a pop-up display presented in a superimposed manner on the first game screen G1 or the selection screen G2. However, the first item selection screen G3 may be displayed after screen transition from the selection screen G2.

The first item selection screen G3 is a screen that allows the player to select a first item to be exchanged for execution of the first game from among first items possessed by the player. The first item selection screen G3 is displayed including a first item information display region 61, a first item use reception portion 62, and a cancel reception portion 63. The first item information display region 61 displays information on a first item associated with the player (i.e., information on a first item possessed by the player). The information can include the name of the first item and the number of possessions.

The first item use reception portion 62 can be a button for executing the first game using the first item associated with the player. Specifically, the first item use reception portion 62 corresponds to the first item associated with the player, and the first game execution unit 251 executes the first game in exchange for the corresponding first item based on an input operation by the player on the first item use reception portion 62.

The cancel reception portion 63 can be a button for returning the screen to the selection screen G2. That is, the display control unit 254 displays the selection screen G2 instead of the first item selection screen G3 based on an input operation by the player on the cancel reception portion 63.

FIG. 7 illustrates an example of the purchase screen G4. The purchase screen G4 is a screen displayed on the display device 13 when the fourth input reception portion 44 receives an input operation by the player. Here, the purchase screen G4 is a pop-up display presented in a superimposed manner on the first game screen G1 or the selection screen G2. However, the purchase screen G4 may be displayed after screen transition from the selection screen G2.

The purchase screen G4 is a screen for the player to purchase a game purchase content. The purchase screen G4 is displayed including a switching portion 71, a game purchase content display region 72, a selection reception portion 73, a detailed display reception portion 74, and a close screen reception portion 75.

The switching portion 71 can be a tab or a button for receiving switching of the type or category of a game purchase content displayed on the purchase screen G4. In one example, for each type or category of another game content other than a first item included in the game purchase content, the switching portion 71 can be provided. Therefore, the player can switch a game purchase content displayed for each type or category by selecting a desired switching portion 71.

Here, the switching portions 71 include a first switching portion 71a, a second switching portion 71b, a third switching portion 71c, and a fourth switching portion 71d. The first switching portion 71a switches the type or category to that of a game purchase content including a first item and a special ticket. The second switching portion 71b switches the type or category to that of a game purchase content including a first item and ordinary clothes. The third switching portion 71c switches the type or category to that of a game purchase content including a first item and stage clothes. The fourth switching portion 71d switches the type or category to that of a game purchase content including a first item and a voting ticket. In the example illustrated in FIG. 7, the first switching portion 71a is selected.

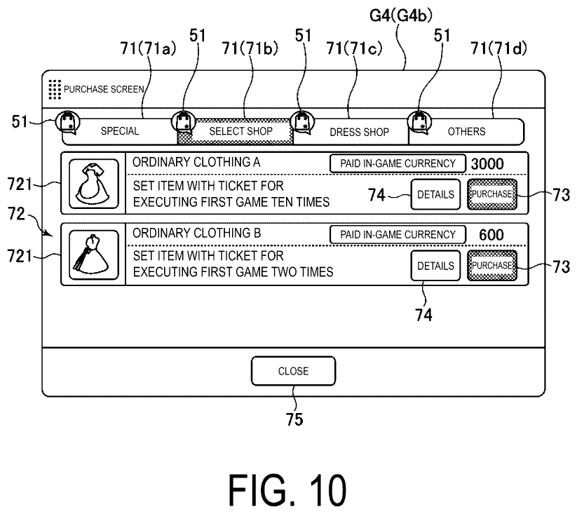

FIGS. 10, 13, and 16 illustrate the purchase screens G4 when the second switching portion 71b, the third switching portion 71c, and the fourth switching portion 71d are selected, respectively. The respective purchase screens G4 in these figures are also referred to as purchase screens G4b, G4c, and G4d. Following this, the purchase screen G4 in FIG. 7 is also referred to as a purchase screen G4a.

As illustrated in FIGS. 7, 10, 13, and 16, a purchasability display 51 may be presented in a manner corresponding to each switching portion 71. In one example, when the determination unit 253 determines that there is a game purchase content that has not been purchased and the game purchase content includes any one of a special ticket, ordinary clothes, stage clothes, and a voting ticket, the display control unit 254 can present at least a part of the purchasability display 51 in a superimposed manner on one of the switching portions 71a to 71d corresponding to the game purchase content including the special ticket, the ordinary clothes, the stage clothes, or the voting ticket. This can notify the player that there is a game content that has not been purchased in each type or category of the game purchase content.

FIGS. 7, 10, 13, and 16 are referred to. The game purchase content display region 72 is a region for displaying a game purchase content having a type or category corresponding to a selected switching portion 71. The game purchase content display region 72 can include one or more game purchase content information displays 721 for displaying information on the game purchase content having the type or category corresponding to the selected switching portion 71. In the example illustrated in FIG. 7, two game purchase content information displays 721 are presented in the game purchase content display region 72. Each game purchase content information display 721 can include the names of a first item and another game content included in the game purchase content, an image of the other game content, and the quantity of predetermined currency to be exchanged for purchase of the game purchase content.

The game purchase contents of the game purchase content information displays 721 illustrated in FIG. 7 are a game purchase content including a set of a special ticket A as another game content and a ticket for executing the first game ten times as a first item, and a game purchase content including a set of a special ticket B as another game content and a ticket for executing the first game two times as a first item. When the quantity of predetermined currency for executing the first game once is 300, the quantity of predetermined currency for each of these game purchase contents can be equal to or less than the quantity of predetermined currency for executing the first game.

The game purchase contents of the game purchase content information displays 721 illustrated in FIG. 10 are a game purchase content including a set of ordinary clothes A as another game content and a ticket for executing the first game ten times as a first item, and a game purchase content including a set of ordinary clothes B as another game content and a ticket for executing the first game two times as a first item. When the quantity of predetermined currency for executing the first game once is 300, the quantity of predetermined currency for each of these game purchase contents can be equal to or less than the quantity of predetermined currency for executing the first game. Note that the ordinary clothes A and B are objects displayed in the rhythm game, and are clothes that a game content such as a character can wear.

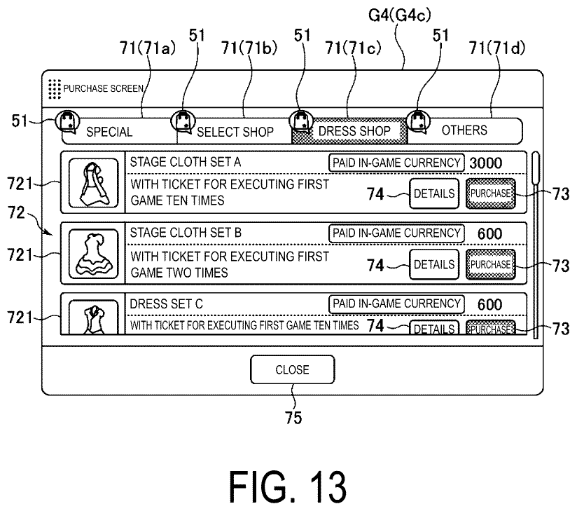

The game purchase contents of the game purchase content information displays 721 illustrated in FIG. 13 are a game purchase content including a set of stage clothes A as another game content and a ticket for executing the first game ten times as a first item, a game purchase content including a set of stage clothes B as another game content and a ticket for executing the first game two times as a first item, and a game purchase content including a set of a dress C as another game content and a ticket for executing the first game ten times as a first item. When the quantity of predetermined currency for executing the first game once is 300, the quantity of predetermined currency for each of these game purchase contents can be equal to or less than the quantity of predetermined currency for executing the first game. Note that the stage clothes A and B are objects displayed in the rhythm game, and are clothes that a game content such as a character can wear.

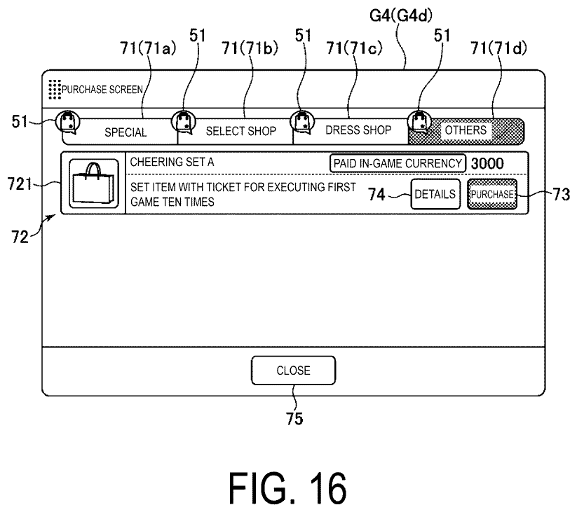

The game purchase content of the game purchase content information display 721 illustrated in FIG. 16 is a game purchase content including a set of a voting ticket as another game content and a ticket for executing the first game ten times as a first item. When the quantity of predetermined currency for executing the first game once is 300, the quantity of predetermined currency for each of these game purchase contents can be equal to or less than the quantity of predetermined currency for executing the first game.

FIGS. 7, 10, 13, and 16 are referred to. The selection reception portion 73 corresponds to a game purchase content in the game purchase content display region 72, and can be a button for receiving selection of the corresponding game purchase content. Specifically, the display control unit 254 displays a purchase confirmation screen G5 based on an input operation by the player on the selection reception portion 73. This display can be a pop-up display. The purchase confirmation screen G5 is a screen for requesting the player to make a confirmation before purchasing the game purchase content corresponding to the selection reception portion 73.

FIGS. 7, 10, 13, and 16 are referred to. The detailed display reception portion 74 is a reception portion for displaying detailed information of a game purchase content. The player performs an input operation on the detailed display reception portion 74, and thus detailed information of a game purchase content corresponding to the detailed display reception portion 74 can be displayed by the display control unit 254. The detailed information can include a breakdown of the game purchase content and detailed descriptions of a first item and another game content included in the game purchase content. When the other game content is ordinary clothes, a dress, or stage clothes, the detailed information can include a display when a game content (for example, a character) wears the other game content. The detailed display reception portion 74 can make it easy for the player to consider purchasing the game purchase content. The detailed display reception portion 74 is displayed in a manner corresponding to a game purchase content displayed on each of the purchase screens G4a to G4d.

FIGS. 7, 10, 13, and 16 are referred to. The close screen reception portion 75 can be a button for returning the screen to the first game screen G1. That is, the display control unit 254 displays the first game screen G1 instead of the purchase screen G4 based on an input operation by the player on the close screen reception portion 75. The close screen reception portion 75 may be a button for returning the screen to the selection screen G2.

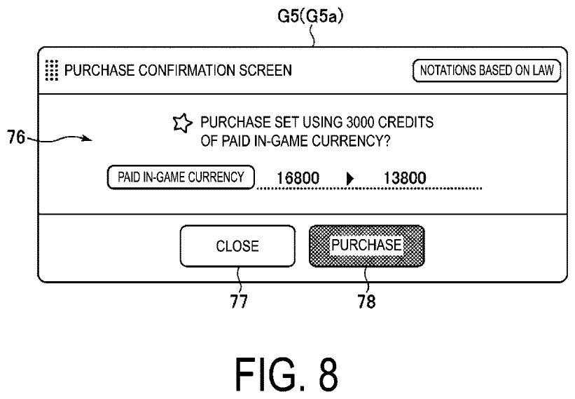

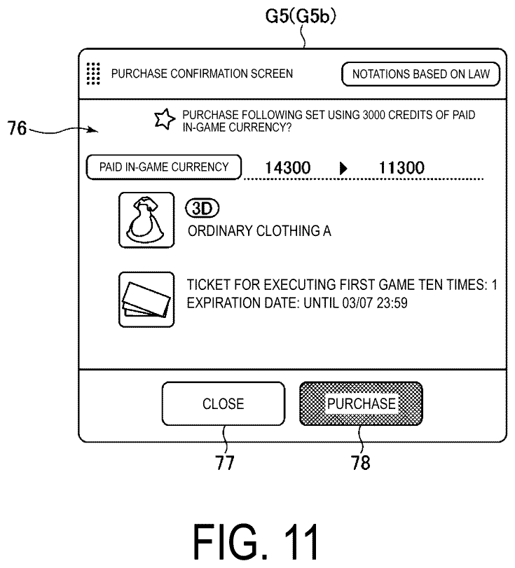

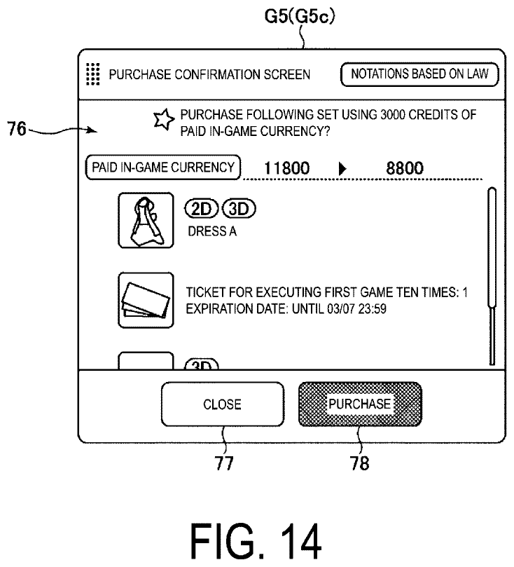

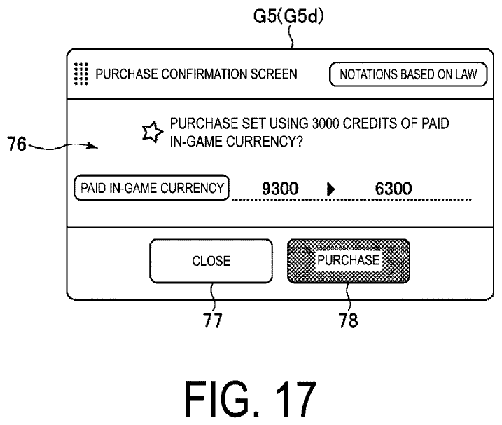

Each of FIGS. 8, 11, 14, and 17 illustrates the purchase confirmation screen G5 displayed through an input operation on the selection reception portion 73 in a corresponding one of FIGS. 7, 10, 13, and 16. The respective purchase confirmation screens G5 are also referred to as purchase confirmation screens G5a to G5d. These purchase confirmation screens G5 are displayed including a game purchase content information display 76, a close screen reception portion 77, and a purchase reception portion 78. The game purchase content information display 76 can include a breakdown of a game purchase content corresponding to the selection reception portion 73 that has been subjected to an input operation, the quantity of predetermined currency currently possessed by the player, the quantity of predetermined currency of the player after purchase of the game purchase content, and a question about whether to purchase the game purchase content. The breakdown of the game purchase content can include the names, images, and descriptions such as expiration dates of a first item and another game content included in the game purchase content. The close screen reception portion 77 can be a button for returning the screen to the purchase screen G4. That is, the display control unit 254 closes the purchase confirmation screen G5 and displays the purchase screen G4 based on an input operation by the player on the close screen reception portion 77. The purchase reception portion 78 is a reception portion for purchasing a game purchase content corresponding to the selection reception portion 73. Specifically, the player performs an input operation on the purchase reception portion 78, and thus the purchase execution unit 252 associates the game purchase content with the player.

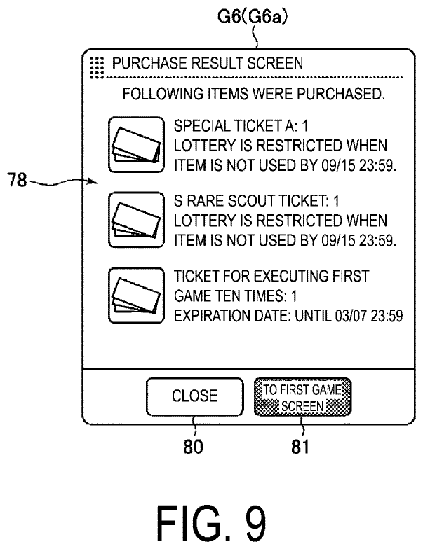

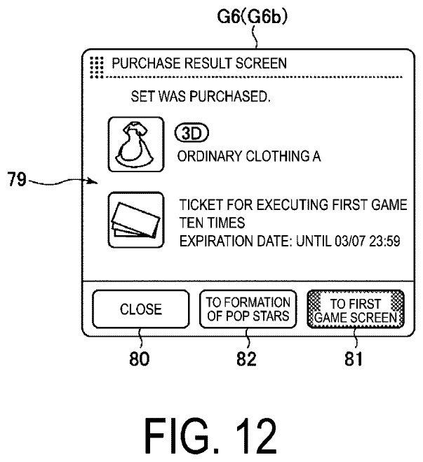

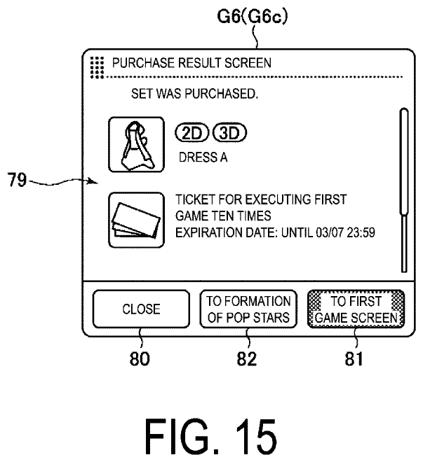

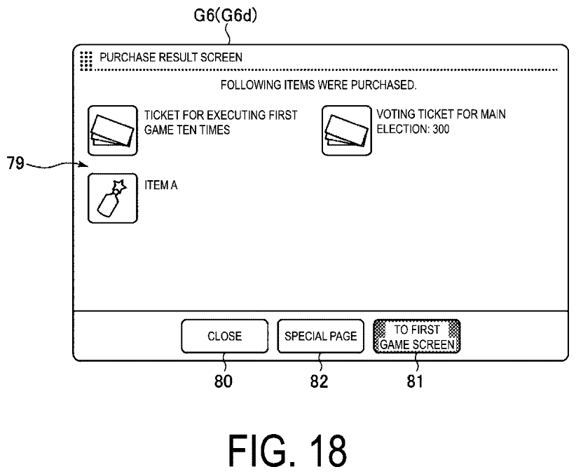

Each of FIGS. 9, 12, 15, and 18 illustrates a purchase result screen G6 indicating that a game purchase content has been purchased through an input operation by the player on the purchase reception portion 78 in a corresponding one of FIGS. 8, 11, 14, and 17. The respective purchase result screens G6 are also referred to as purchase result screens G6a to G6d. These purchase result screens G6 are displayed including a purchased game content information display 79, a close screen reception portion 80, and a transition reception portion 81. The purchased game content information display 79 includes detailed information of a game purchase content that has been purchased. The detailed information can include the names, quantities, images, descriptions, and use restrictions of a first item and another game content. The close screen reception portion 80 can be a button for closing the purchase result screen G6. Specifically, the display control unit 254 closes the purchase result screen G6 and displays the purchase screen G4 through an input operation by the player on the close screen reception portion 80. The transition reception portion 81 can be a button for closing the purchase result screen G6 and returning the screen to the first game screen G1. Specifically, the display control unit 254 closes the purchase result screen G6 and displays the first game screen G1 through an input operation by the player on the transition reception portion 81.

The purchase result screens G6b and G6c can include a formation reception portion 82. The formation reception portion 82 can be a button for displaying a formation screen (not illustrated). Specifically, the display control unit 254 displays the formation screen based on an input operation by the player on the formation reception portion 82. On the formation screen, another game content (for example, purchased clothes such as ordinary clothes, a dress, or stage clothes) included in a game purchase content that has been purchased can be used for each member of a character group (for example, a pop star group) formed by the player, and the formation of the group can be registered. Accordingly, it is possible to immediately use the other game content that has been purchased, which can improve the player's friendliness. The formation screen is a screen also displayed through an input operation on the formation button 34.

The purchase result screen God can include a voting screen transition reception portion 83. The voting screen transition reception portion 83 can be a button for displaying a voting screen (not illustrated). Specifically, the display control unit 254 displays the voting screen based on an input operation by the player on the voting screen transition reception portion 83. The voting screen is a screen on which the player can vote, in an in-game general election, for a game content (for example, a character) selected by the player from among a plurality of game contents usable in the game in exchange for a voting ticket possessed by the player. As a result of the voting, it is possible to give a privilege to a highly ranked character, such as allowing the character to make a sound or giving the character a song to be sung on the stage.

FIG. 19 is another example of the first game screen G1. The first game screen G1 illustrated in FIG. 19 can include a possession display 91 indicating that the player possesses a first item. The possession display 91 is only required to be presented in the first game screen G1, but, as illustrated in FIG. 19, at least a part thereof may be presented such that it is superimposed on each first input reception portion 41. Superimposing at least a part of the possession display 91 on the first input reception portion 41 can include providing the possession display 91 at a position corresponding to the first input reception portion 41, or in the vicinity, around, or in the periphery of the first input reception portion 41.

Specifically, when the player possesses a first item, the display control unit 254 can present the possession display 91 in the first game screen G1. More specifically, when the first game screen G1 is displayed on the display device 13 based on an input operation by the player on the first game button 33, the display control unit 254 determines whether the quantity of first items associated with the player is one or more. When the quantity is one or more, the possession display 91 can be presented in the first game screen G1. Note that when the quantity is zero and the determination unit 253 determines that there is a game purchase content that can be purchased by the player, the display control unit 254 can present the purchasability display 51 instead of the possession display 91 in the first game screen G1. The possession display 91 corresponding to the first input reception portion 41a can be a possession display 91a, and the possession display 91 corresponding to the first input reception portion 41b can be a possession display 91b. That is, the possession display 91a indicates that the player possesses a first item that allows execution of the first game once, and the possession display 91b indicates that the player possesses a first item that allows execution of the first game a plurality of times.

### Operation

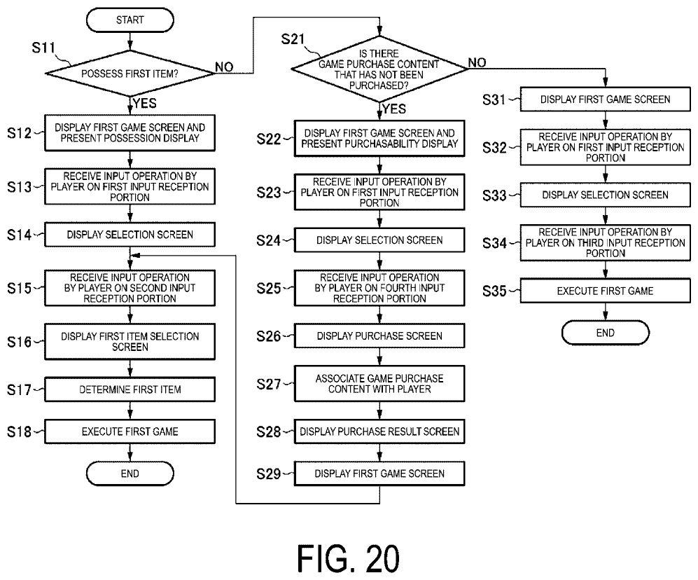

FIG. 20 is an example of an operation flowchart of the information processing apparatus 10 according to the embodiment of the present invention. The operation flowchart of FIG. 20 relates to execution of the first game, and it is assumed that the home screen including the switching portion 30 is displayed on the display device 13 as an initial state.

First, when the information processing apparatus 10 receives an input operation by the player on the first game button 33, the display control unit 254 determines whether the player possesses a first item (S11). Specifically, the display control unit 254 determines whether the quantity of first items associated with the player is one or more. When the quantity is one or more, the display control unit 254 determines that the player possesses a first item (YES in S11), and causes the display device 13 to display the first game screen G1 and present the possession display 91 in the first game screen G1 (S12). The possession display 91 allows the player to recognize that the player possesses a first item.

The information processing apparatus 10 receives an input operation by the player on the first input reception portion 41 (S13), and causes the display control unit 254 to display the selection screen G2 (S14). Then, the information processing apparatus 10 receives an input operation by the player on the second input reception portion 42 (S15), and causes the display control unit 254 to display the first item selection screen G3 (S16). A list of first items possessed by the player is displayed on the first item selection screen G3. The information processing apparatus 10 receives an input operation by the player on the first item use reception portion 62 corresponding to any of the first items. Thus, the first game execution unit 251 determines the first item (S17), and executes the first game in exchange for the first item (S18). Along with the execution, the first game execution unit 251 can change the quantity of first items associated with the player and associate a game content acquired by the lottery with the player. Note that, after the execution of the first game, it is possible to return the screen to the home screen or the first game screen G1.

On the other hand, when the quantity of first items associated with the player is zero (NO in S11), the determination unit 253 determines, based on purchasability/unpurchasability information of a game purchase content associated with the player, whether the player can purchase the game purchase content (S21). Specifically, since the player and the purchasability/unpurchasability information are associated with a plurality of game purchase contents, the determination unit 253 determines whether each piece of the purchasability/unpurchasability information associated with the player is data indicating that purchase is possible or data indicating that purchase is impossible.

When the purchasability/unpurchasability information of at least one game purchase content is data indicating that purchase is possible, the determination unit 253 determines that there is a game purchase content that has not been purchased (YES in S21) and outputs the determination result to the display control unit 254. Then, the display control unit 254 causes the display device 13 to display the first game screen G1 including the first input reception portion 41, and also presents, in the first game screen G1, the purchasability display 51 indicating that the game purchase content is purchasable (S22).

The information processing apparatus 10 receives an input operation by the player on the first input reception portion 41 (S23), and causes the display control unit 254 to display the selection screen G2 (S24). Then, the information processing apparatus 10 receives an input operation by the player on the fourth input reception portion 44 (S25), and causes the display control unit 254 to display the purchase screen G4 (S26). In the purchase screen G4, a game purchase content that has not been purchased by the player is displayed for each type or category (for example, for each of the switching portions 71a to 71d). The display control unit 254 can present at least a part of the purchasability display 51 in a superimposed manner on each switching portion 71 where there is a game purchase content that has not been purchased (see FIGS. 7, 10, 13, and 16). The information processing apparatus 10 receives an input operation by the player on the selection reception portion 73 corresponding to any game purchase content from the player, and causes the display control unit 254 to display the purchase confirmation screen G5. Then, an input from the player to the purchase reception portion 78 is received on the purchase confirmation screen G5, and the purchase execution unit 252 associates the game purchase content with the player in exchange for predetermined currency (S27). At this time, the purchase execution unit 252 stores the game purchase content in the storage device 14 in association with the player, subtracts the predetermined currency corresponding to the game purchase content from predetermined currency of the player, and stores predetermined currency after the subtraction in the storage device 14 in association with the player. In this way, the player can purchase a first item and another game content other than the first item (for example, a special ticket, ordinary clothes, a dress, stage clothes, or a voting ticket) in exchange for the predetermined currency. The quantity of the exchanged predetermined currency is equal to or less than the quantity of predetermined currency required for purchasing the first item. Therefore, because the other game content can be acquired, the player's game experience can be improved by purchasing the game purchase content rather than purchasing only the first item.

After S27, the display control unit 254 causes the display device 13 to display the purchase result screen G6 (S28). Thereafter, the display control unit 254 displays the first game screen G1 based on an input operation by the player on the transition reception portion 81. At this time, the display control unit 254 can present at least a part of the possession display 91 in a superimposed manner on the first input reception portion 41 of the first game screen G1. Thereafter, the processing proceeds to S15, and S15 to S18 are executed. Note that each of the first item displayed on the first item selection screen G3 in S16 and the first item determined in S17 is the first item included in the game purchase content purchased in S27.

When the purchasability/unpurchasability information of any game purchase content is data indicating that purchase is impossible, the determination unit 253 determines that there is no game purchase content that has not been purchased (NO in S21), and outputs the determination result to the display control unit 254. Then, the display control unit 254 causes the display device 13 to display the first game screen G1 including the first input reception portion 41 (S31). On the first game screen G1, neither the possession display 91 nor the purchasability display 51 is presented.

The information processing apparatus 10 receives an input operation by the player on the first input reception portion 41 (S32), and causes the display control unit 254 to display the selection screen G2 (S33). Then, the information processing apparatus 10 receives an input operation by the player on the third input reception portion 43 (S34), and causes the first game execution unit 251 to execute the first game in exchange for predetermined currency (S35). Note that, after the execution of the first game, it is possible to return the screen to the home screen or the first game screen G1.

### Actions and Effects

(1) The information processing apparatus 10 of the present embodiment is an information processing apparatus for executing a game, the information processing apparatus including the first game execution unit 251 executing the first game included in the game in exchange for a first item or predetermined currency based on an operation on the first input reception portion 41 for executing the first game, the purchase execution unit 252 associating the player who purchases a game purchase content including at least the first item with the game purchase content in exchange for the predetermined currency, the determination unit 253 determining, based on purchasability/unpurchasability information associated with the player of the game purchase content, whether the game purchase content is purchasable by the player, and the display control unit 254 presenting, when it is determined that the game purchase content is purchasable, the purchasability display 51 in the first game screen G1 including the first input reception portion 41, the purchasability display indicating that the game purchase content is purchasable.

This can notify the player that the game purchase content including the first item is purchasable, and thus it is possible to improve the player's game experience. That is, when there is no purchasability display 51, the player may execute the first game in exchange for the predetermined currency without noticing the game purchase content that has not been purchased, but because of the presence of the purchasability display 51, it is possible to prompt the player to select whether to execute the first game in exchange for the predetermined currency or to purchase the game purchase content including the first item and then execute the first game in exchange for the first item.

(2) The game purchase content includes the first item and another game content that is different from the first item and that is usable in the game.

This can improve the player's game experience. For example, by displaying the purchasability display 51, the player purchases the game purchase content including the first item that allows execution of the first game before executing the first game in exchange for the predetermined currency, and executes the first game in exchange for the purchased first item. Thus, because the other game content can be acquired, the player's game experience can be improved by purchasing the game purchase content and then executing the first game in exchange for the first item rather than executing the first game in exchange for the predetermined currency when the same first game is executed.

(3) The display control unit 254 displays at least a part of the purchasability display 51 in a superimposed manner on the first input reception portion 41 in the first game screen G1. This can make it easy for the player who is about to execute the first game to notice the presence of the game purchase content that has not been purchased.

(4) The display control unit 254 directly transitions, based on a predetermined operation by the player, the first game screen G1 to a purchase screen for purchasing the game purchase content.

This can induce the player to purchase the game purchase content, and thus it is possible to improve the player's friendliness. Note that the expression “directly transition” can include completely switching the screen from the first game screen G1 to the purchase screen G4, and, as described in the embodiment, a pop-up display in which the purchase screen G4 is displayed in a superimposed manner on the first game screen G1 in a state in which the first game screen G1 is displayed on the display device 13.

(5) The display control unit 254 displays, based on a predetermined operation by the player, the selection screen G2 including the second input reception portion 42 and the third input reception portion 43, the second input reception portion 42 being for executing the first game in exchange for the first item, the third input reception portion 43 being for executing the first game in exchange for the predetermined currency, and the first game execution unit 251 executes the first game based on selection of the second input reception portion 42 or the third input reception portion 43 by the player.

This allows the player to select which of the first item and the predetermined currency is to be exchanged in order to execute the first game.

(6) The selection screen G2 further includes the fourth input reception portion 44 for purchasing the game purchase content.

This allows the player to select which of the first item and the predetermined currency is to be exchanged in order to execute the first game. Then, when the first item is to be exchanged, it is possible to induce the player to purchase the game purchase content including the first item using the fourth input reception portion 44.

(7) When the player possesses the first item, the display control unit 254 presents, in the first game screen G1, the possession display 91 indicating that the player possesses the first item.

This can prompt the player to exchange the first item rather than the predetermined currency when the first game is executed, and thus it is possible to improve the player's game experience. That is, the first item can be used only for execution of the first game and the predetermined currency can be used not only for execution of the first game but also for exchange for another game content. Thus, the predetermined currency can be left by preferentially using the first item when the player possesses the first item at the time of execution of the first game, thereby enabling the predetermined currency to be used for another purpose. As a result, the player can have a variety of game experiences.

### Modified Example

A modified example of the above-described embodiment will be described. Configurations similar to those of the above-described embodiment are denoted by the same reference numerals, descriptions thereof are appropriately omitted, and configurations different from those of the above-described embodiment are described.

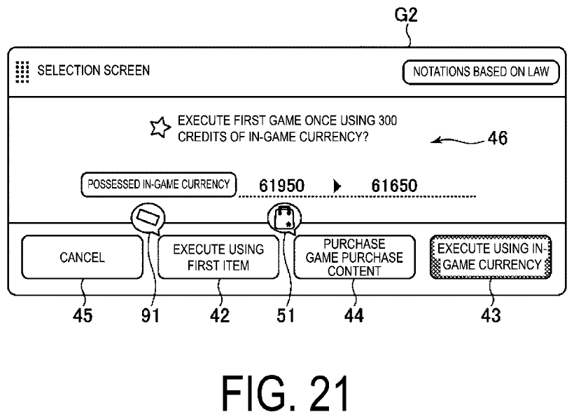

(1) FIG. 21 illustrates an example of a selection screen G2 according to a modified example of the embodiment. The possession display 91 and/or the purchasability display 51 may be presented in the selection screen G2. This can notify the player that the player possesses a first item before the first game is executed and/or that there is a game purchase content that has not been purchased before the first game is executed, which can improve the player's game experience.

In particular, as illustrated in FIG. 21, the display control unit 254 may present at least a part of the possession display 91 in a superimposed manner on the second input reception portion 42 or the third input reception portion 43 in the selection screen G2, or may display at least a part of the purchasability display 51 in a superimposed manner on the third input reception portion 43 or the fourth input reception portion 44 in the selection screen G2 together with or instead of the possession display 91. Such a configuration can make it easy for the player who is about to execute the first game to notice the presence of the first item, and also can induce the player to use the first item. As a result, it is possible to improve the player's friendliness. In addition, it is possible to make it easy for the player who is about to execute the first game to notice that there is a game purchase content that has not been purchased and to induce the player to purchase the game purchase content that has not been purchased. As a result, it is possible to improve the player's friendliness.

For example, the possession display 91 may be presented on the selection screen G2 in S14 and S28 in FIG. 20, and the purchasability display 51 may be presented on the selection screen G2 in S14 and S24 in FIG. 20. In particular, the possession display 91 may be displayed such that it is superimposed on at least a part of the second input reception portion 42 and/or the third input reception portion 43, and the purchasability display 51 may be displayed such that it is superimposed on at least a part of the fourth input reception portion 44 and/or the third input reception portion 43.

Superimposing the possession display 91 on at least a part of the second input reception portion 42 and/or the third input reception portion 43 can include providing the possession display 91 at a position corresponding to the second input reception portion 42 and/or the third input reception portion 43, or in the vicinity of, around, or in the periphery of the second input reception portion 42 and/or the third input reception portion 43. Superimposing the purchasability display 51 on at least a part of the fourth input reception portion 44 and/or the third input reception portion 43 can include providing the purchasability display 51 at a position corresponding to the fourth input reception portion 44 and/or the third input reception portion 43, or in the vicinity of, around, or in the periphery of the fourth input reception portion 44 and/or the third input reception portion 43.

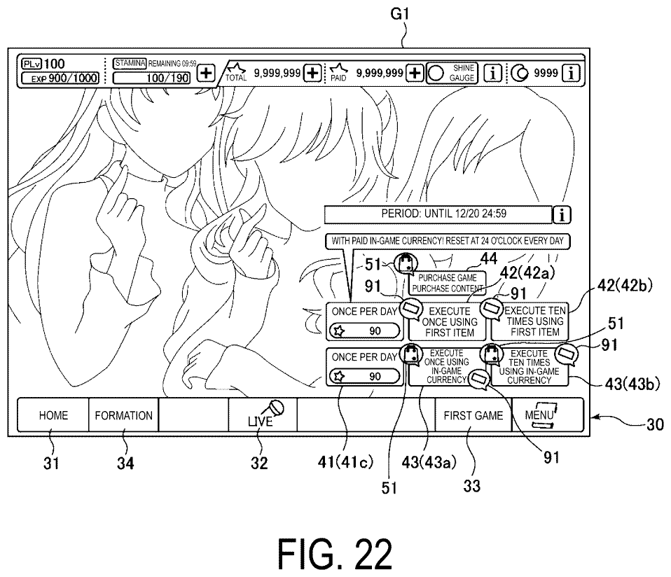

(2) FIG. 22 illustrates an example of a first game screen G1 according to the modified example of the embodiment. Instead of displaying the first game screen G1 and the selection screen G2, the display control unit 254 may display a first game screen G1 illustrated in FIG. 22. That is, the first game screen G1 according to the modified example includes the second input reception portion 42, the third input reception portion 43, and the fourth input reception portion 44. Since both of the second input reception portion 42 and the third input reception portion 43 are for executing the first game, each portion can be used as one type of the first input reception portion 41 for executing the first game. A plurality of the second input reception portions 42 and a plurality of the third input reception portions 43 can be displayed on the first game screen G1.

That is, a second input reception portion 42a in FIG. 22 is an input reception portion for executing the first game once in exchange for a first item. A second input reception portion 42b in FIG. 22 is an input reception portion for executing the first game ten times in exchange for a first item. Note that the former first item is an item (for example, a ticket) for executing the first game once, and the latter first item is an item (for example, a ticket) for executing the first game ten times.

A third input reception portion 43a in FIG. 22 is a reception portion for executing the first game once in exchange for predetermined currency for executing the first game once. A third input reception portion 43b in FIG. 22 is a reception portion for executing the first game ten times in exchange for predetermined currency for executing the first game ten times.

The possession display 91 may be presented in a superimposed manner on at least a part of the second input reception portion 42. The possession display 91 and/or the purchasability display 51 may be presented in a superimposed manner on at least a part of the third input reception portion 43. The purchasability display 51 may be presented in a superimposed manner on at least a part of the fourth input reception portion 44.

Note that when the player selects the cancel reception portion 63 of the first item selection screen G3 or the cancel reception portion 75 of the purchase screen G4, the screen returns to the first game screen G1 illustrated in FIG. 22, not to the selection screen G2.

In the present modified example, the first input reception portion 41 includes the second input reception portion 42 for executing the first game in exchange for a first item and the third input reception portion 43 for executing the first game in exchange for predetermined currency, the display control unit 254 displays the second input reception portion 42 and the third input reception portion 43 such that these portions are included in the first game screen G1, and the first game execution unit 251 executes the first game based on selection of the second input reception portion 42 or the third input reception portion 43 by the player.

This allows the player to select which of the first item and the predetermined currency is to be exchanged in order to execute the first game.

In addition, since the possession display 91 and/or the purchasability display 51 is presented in the first game screen G1, the player's game experience can be improved.

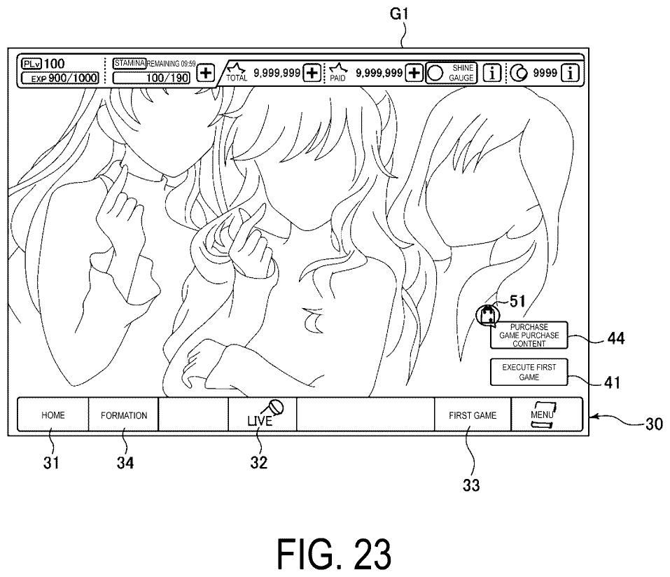

(3) FIG. 23 is another example of the first game screen G1 according to the modified example of the embodiment. Instead of displaying the first game screen G1 and the selection screen G2, the display control unit 254 may display a first game screen G1 illustrated in FIG. 23. That is, the first game screen G1 according to the modified example includes the first input reception portion 41 and the fourth input reception portion 44. The number of the first input reception portions 41 is one here. The first game execution unit 251 can determine whether the player possesses a first item based on an operation by the player on the first input reception portion 41. When the player possesses a first item, the first game execution unit 251 executes the first game in exchange for the first item. When the player possesses no first item, the first game execution unit 251 executes the first game in exchange for predetermined currency.

With such a configuration, the first item having a low degree of freedom in exchange can be preferentially used rather than the predetermined currency having a high degree of freedom in exchange. Thus, it is possible to improve the player's game experience. That is, the first item can be used only for execution of the first game and the predetermined currency can be used not only for execution of the first game but also for exchange for another game content. Thus, the predetermined currency can be left by preferentially using the first item when the player possesses the first item at the time of execution of the first game, thereby enabling the predetermined currency to be used for another purpose. As a result, the player can have a variety of game experiences.

When there is a game purchase content that has not been purchased and that corresponds to purchasability/unpurchasability information associated with the player, and the purchasability/unpurchasability information is data indicating that purchase is possible, the display control unit 254 may present the purchasability display 51 in the first game screen G1. In addition, the purchasability display 51 may be presented in a superimposed manner on at least a part of the fourth input reception portion 44.

Note that when the player selects the cancel reception portion 75 of the purchase screen G4, the screen returns to the first game screen G1 illustrated in FIG. 23, not to the selection screen G2.

### Embodiment Achieved by System

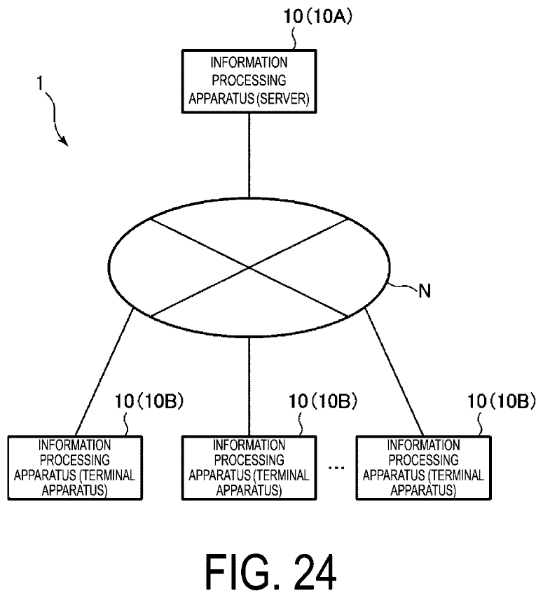

FIG. 24 is a diagram illustrating an example of an overall configuration of the game system according to the embodiment of the present invention. As illustrated in FIG. 24, a game system 1 includes a plurality of the information processing apparatuses 10. At least one of the plurality of information processing apparatuses 10 is a server 10A, and the other information processing apparatuses 10 are terminal apparatuses 10B used by respective players. The server 10A and each terminal apparatus 10B are connected to a network N such as the Internet in a mutually communicable manner. Note that the game system 1 of the present embodiment will be described on the assumption that it is a server-client system, but can be configured as a system without the server 10A, such as PtoP.

The terminal apparatus 10B and the server 10A have the same hardware configuration as that illustrated in FIG. 1, and the terminal apparatus 10B is assumed to be a smartphone also in the present embodiment. The server 10A is a server apparatus that provides a game executable in the terminal apparatus 10B, and includes one or more computers.

The server 10A stores various programs such as a control program for controlling a progress of an online game and various types of data used in the game.

In one example, the server 10A is configured to provide the terminal apparatus 10B with a game application executable in the terminal apparatus 10B. When executing the downloaded game application, the terminal apparatus 10B transmits and receives data to and from the server 10A periodically or as necessary and proceeds the game. For example, the server 10A stores various types of setting information, history information, and the like necessary for the game executed in the terminal apparatus 10B. In this case, the terminal apparatus 10B has functions of the units 21 to 25 and the functional units in the game control unit 25.

In another example, the server 10A is a web server and provides a game service to the terminal apparatus 10B. The terminal apparatus 10B acquires HTML data for displaying a web page from the server 10A, analyzes the acquired HTML data, and displays the web page. In this case, the server 10A that communicates with the terminal apparatus 10B has all or some of the functions of the game control unit 25. For example, the terminal apparatus 10B receives selection of one of the input reception portions 41 to 44 by the player via the input part 21 (input device 12), and transmits the selection to the server 10A. Based on the selection, the server 10A causes the units 251 to 254 of the server 10A to perform various determinations, display control of the display device 13 of the terminal apparatus 10B, purchase of a game purchase content, and execution of the first game. All or some of the functions of the game control unit 25 may be distributed to the server 10A and the terminal apparatus 10B.

### Other Embodiments

In another embodiment of the present invention, a program for implementing the functions of the above-described embodiment of the present invention and the information processing illustrated in the flowchart, and a computer-readable storage medium storing the program can be provided. In still another embodiment, a method for implementing the functions of the above-described embodiment of the present invention and the information processing illustrated in the flowchart can be provided. In still another embodiment, a server that can supply a computer with a program for implementing the functions of the above-described embodiment of the present invention and the information processing illustrated in the flowchart can be provided. In still another embodiment, a virtual machine for implementing the functions of the above-described embodiment of the present invention and the information processing illustrated in the flowchart can be provided.

The processing or operation described above can be freely changed as long as a contradiction in the processing or operation does not occur, for example, use of data in a certain step that should be not usable in the step. Each of the examples described above is an example for describing the present invention, and the present invention is not limited to these examples. The present invention can be carried out in various forms without departing from the gist thereof.

### REFERENCE SIGNS LIST

1 Game system
10 Information processing apparatus
10A Terminal apparatus
10B Server
11 Processor
12 Input device
13 Output device
14 Storage device
15 Communication device
16 Bus
21 Input part
22 Output part
23 Storage unit
24 Communication unit
25 Game control unit
251 First game execution unit
252 Purchase execution unit
253 Determination unit
254 Display control unit
G1 First game screen
30 Mode switching portion
31 Home button
32 Rhythm game button
33 First game button
34 Formation button
41 First input reception portion
G2 Selection screen
42 Second input reception portion
43 Third input reception portion
44 Fourth input reception portion
45 Cancel reception portion
46 Confirmation display region
G3 First item selection screen
61 First item information display region
62 First item use reception portion
63 Cancel reception portion
G4 Purchase screen
71 Switching portion
72 Game purchase content display region
721 Game purchase content information display
73 Selection reception portion
74 Detailed display reception portion
75 Close screen reception portion
76 Game purchase content information display
77 Close screen reception portion
78 Purchase reception portion
79 Purchased game content information display
80 Close screen reception portion
81 Transition reception portion
82 Formation reception portion
83 Voting screen transition reception portion
91 Possession display
N Network

1. A non-transitory computer readable medium storing a program for a game, the program causing a computer to function as:
a first game executor configured to execute a first game included in the game in exchange for a first item or predetermined currency based on an operation on a first input reception portion configured to allow execution of the first game;
a purchase executor configured to associate a player who purchases a game purchase content including at least the first item with the game purchase content in exchange for the predetermined currency;
a determiner configured to determine, based on purchasability/unpurchasability information associated with the player of the game purchase content, whether the game purchase content is purchasable by the player; and
a display controller configured to present, when it is determined that the game purchase content is purchasable, a purchasability display in a game screen including the first input reception portion, the purchasability display indicating that the game purchase content is purchasable.

2. The non-transitory computer readable medium according to claim 1, wherein
the game purchase content includes the first item and another game content that is different from the first item and that is usable in the game.

3. The non-transitory computer readable medium according to claim 1, wherein
the display controller directly transitions, based on a predetermined operation by the player, the game screen to a purchase screen configured to allow purchase of the game purchase content.

4. The non-transitory computer readable medium according to claim 1, wherein
the display controller displays, based on a predetermined operation by the player, a selection screen including a second input reception portion and a third input reception portion, the second input reception portion being configured to allow execution of the first game in exchange for the first item, the third input reception portion being configured to allow execution of the first game in exchange for the predetermined currency, and
the first game executor executes the first game based on selection of the second input reception portion or the third input reception portion by the player.

5. The non-transitory computer readable medium according to claim 4, wherein
the selection screen further includes a fourth input reception portion configured to allow purchase of the game purchase content.

6. The non-transitory computer readable medium according to claim 1, wherein
the first input reception portion includes a second input reception portion and a third input reception portion, the second input reception portion being configured to allow execution of the first game in exchange for the first item, the third input reception portion being configured to allow execution of the first game in exchange for the predetermined currency,
the display controller displays the second input reception portion and the third input reception portion such that the second input reception portion and the third input reception portion are included in the game screen, and
the first game executor executes the first game based on selection of the second input reception portion or the third input reception portion by the player.

7. The non-transitory computer readable medium according to claim 1, wherein
the first game executor determines whether the player possesses the first item based on an operation by the player on the first input reception portion, executes the first game in exchange for the first item when the player possesses the first item, and executes the first game in exchange for the predetermined currency when the player does not possess the first item.

8. The non-transitory computer readable medium according to claim 1, wherein
when the player possesses the first item, the display controller presents, in the game screen, a possession display indicating that the player possesses the first item.

9. The non-transitory computer readable medium according to claim 1, comprising at least one or more of the following configurations [2] to [8]:
[2] the game purchase content includes the first item and another game content that is different from the first item and that is usable in the game;
[3] the display controller directly transitions, based on a predetermined operation by the player, the game screen to a purchase screen configured to allow purchase of the game purchase content;
[4] the display controller displays, based on a predetermined operation by the player, a selection screen including a second input reception portion and a third input reception portion, the second input reception portion being configured to allow execution of the first game in exchange for the first item, the third input reception portion being configured to allow execution of the first game in exchange for the predetermined currency, and
the first game executor executes the first game based on selection of the second input reception portion or the third input reception portion by the player;
[5] in the configuration [4], the selection screen further includes a fourth input reception portion configured to allow purchase of the game purchase content;
[6] the first input reception portion includes a second input reception portion and a third input reception portion, the second input reception portion being configured to allow execution of the first game in exchange for the first item, the third input reception portion being configured to allow execution of the first game in exchange for the predetermined currency,
the display controller displays the second input reception portion and the third input reception portion such that the second input reception portion and the third input reception portion are included in the game screen, and
the first game executor executes the first game based on selection of the second input reception portion or the third input reception portion by the player;
[7] the first game executor determines whether the player possesses the first item based on an operation by the player on the first input reception portion, executes the first game in exchange for the first item when the player possesses the first item, and executes the first game in exchange for the predetermined currency when the player does not possess the first item; and
[8] when the player possesses the first item, the display controller presents, in the game screen, a possession display indicating that the player possesses the first item.

10. An information processing apparatus for executing a game, the information processing apparatus comprising:
a first game executor configured to execute a first game included in the game in exchange for a first item or predetermined currency based on an operation on a first input reception portion configured to allow execution of the first game;
a purchase executor configured to associate a player who purchases a game purchase content including at least the first item with the game purchase content in exchange for the predetermined currency;
a determiner configured to determine, based on purchasability/unpurchasability information associated with the player of the game purchase content, whether the game purchase content is purchasable by the player; and
a display controller configured to present, when it is determined that the game purchase content is purchasable, a purchasability display in a game screen including the first input reception portion, the purchasability display indicating that the game purchase content is purchasable.

11. A method for a game, the method comprising:
a first game execution step of executing a first game included in the game in exchange for a first item or predetermined currency based on an operation on a first input reception portion configured to allow execution of the first game;
a purchase execution step of associating a player who purchases a game purchase content including at least the first item with the game purchase content in exchange for the predetermined currency;
a determination step of determining, based on purchasability/unpurchasability information associated with the player of the game purchase content, whether the game purchase content is purchasable by the player; and
a display control step of presenting, when it is determined that the game purchase content is purchasable, a purchasability display in a game screen including the first input reception portion, the purchasability display indicating that the game purchase content is purchasable.

12. A system for executing a game, the system comprising:
a plurality of information processing apparatuses, wherein
at least any of the plurality of information processing apparatuses functions as a first game executor configured to execute a first game included in the game in exchange for a first item or predetermined currency based on an operation on a first input reception portion configured to allow execution of the first game;
at least any of the plurality of information processing apparatuses functions as a purchase executor configured to associate a player who purchases a game purchase content including at least the first item with the game purchase content in exchange for the predetermined currency;
at least any of the plurality of information processing apparatuses functions as a determiner configured to determine, based on purchasability/unpurchasability information associated with the player of the game purchase content, whether the game purchase content is purchasable by the player; and
at least any of the plurality of information processing apparatuses functions as a display controller configured to present, when it is determined that the game purchase content is purchasable, a purchasability display in a game screen including the first input reception portion, the purchasability display indicating that the game purchase content is purchasable.
